(19) United States
(12) Patent Application Publication
(10) Pub. No.: US 2011/0009189 A1
(43) Pub. Date: Jan. 13, 2011

(54) GAMING MACHINE DISPLAY MOUNT ASSEMBLY

(76) Inventors: R. Jeff Jordan, Las Vegas, NV (US); Kim L. Martin, Las Vegas, NV (US)

Correspondence Address: Armstrong Teasdale LLP (IGT - 26668);Robert B. Reeser, III, 7700 Forsyth Boulevard, Suite 1800, St. Louis, MO, 63105, US

(21) Appl. No.: 12/498,542

(22) Filed: Jul. 7, 2009

(51) Int. Cl. A63F 13/00; A63F 9/24

(52) U.S. Cl. 463/30; 463/46

(57) ABSTRACT

A gaming machine includes a display having a receptacle positioned on a rear surface of said display, and a display mount assembly that couples the gaming machine to a mounting surface. The display mount assembly includes a support arm having a first end and an opposite second end, wherein the first end is coupled to the mounting surface, and a pivot joint coupled to the receptacle and to the support arm second end such that the pivot joint provides movement of the display along at least two axes.

### BACKGROUND OF THE INVENTION

The embodiments described herein relate generally to gaming machines and, more particularly, to support assemblies used to support gaming machine displays.

At least some known gaming machines are installed within a countertop such that a video display is positioned flush, or nearly flush, to a horizontally-aligned or surrounding bar top. However, in order to maintain an optimum viewing angle and a minimum parallax, a player of such a gaming machine is often required to lean over the countertop in order to orient his line of sight essentially perpendicular to an outer surface of the video display. Because such positions are often uncomfortable, many players are reluctant or unable to maintain such a seated position for an appreciable period of time, and instead accept viewing the video display from an oblique angle. Such a position may be compromised by glare from overhead lights that may obstruct a portion of the video display.

Moreover, in many casinos or alternative gaming locations, a bar countertop is among the busiest gathering points for customers. As such, there may be groups of customers that wish to collectively view or participate in a game using a single gaming machine. Just as at least some flush mount video displays compromise the visibility of a single player, the visibility of multiple players may also be compromised by, for example, glare from overhead lights. Furthermore, although bar countertops may be a popular gathering point, a single player may wish to screen neighboring customers from his video display to, for example, avoid unwanted advice.

### BRIEF DESCRIPTION OF THE INVENTION

This Brief Description is provided to introduce a selection of concepts in a simplified form that are further described below in the Detailed Description. This Brief Description is not intended to identify key features or essential features of the claimed subject matter, nor is it intended to be used as an aid in determining the scope of the claimed subject matter.

In one aspect, a gaming machine is provided. The gaming machine includes a display having a receptacle positioned on a rear surface, and a display mount assembly that couples the gaming machine to a mounting surface. The display mount assembly includes a support arm having a first end and an opposite second end, wherein the first end is coupled to the mounting surface, and a pivot joint coupled to the receptacle and to the support arm second end such that the pivot joint provides movement of the display along at least two axes.

In another aspect, a display mount assembly is provided for use with a gaming machine that includes a display. The display mount assembly includes a support arm having a first end and an opposite second end, wherein the first end is coupled to a mounting surface, and a pivot joint coupled to the display and to the second end such that the pivot joint provides movement of the display along at least two axes.

In another aspect, a method is provided for assembling a gaming machine that includes a display and a display mount assembly having a support arm and a pivot joint. The method includes coupling a first end of the support arm to a mounting surface, coupling a second end of the support arm to the pivot joint, and coupling the pivot joint to the display such that the pivot joint provides movement of the display along at least two axes.

### BRIEF DESCRIPTION OF THE DRAWINGS

The embodiments described herein may be better understood by referring to the following description in conjunction with the accompanying drawings.

FIG. 1 is a top schematic diagram of an exemplary gaming machine;

FIG. 2 is a front schematic diagram of the gaming machine shown in FIG. 1;

FIG. 3 is an isometric schematic diagram of the gaming machine shown in FIG. 1;

FIG. 4 is a side schematic diagram of the gaming machine shown in FIG. 1;

FIG. 5 is an isometric schematic diagram of the gaming machine shown in FIGS. 1-4 that illustrates relative movement of a display component of the gaming machine generally along the y-axis;

FIG. 6 is a side schematic diagram of the gaming machine shown in FIGS. 1-4 that illustrates the relative movement of a display component of the gaming machine generally along the y-axis;

FIG. 7 is an isometric schematic diagram of the gaming machine shown in FIGS. 1-4 that illustrates relative movement of a display component of the gaming machine generally along the z-axis;

FIG. 8 is a block diagram of an exemplary electrical architecture of the gaming machine shown in FIGS. 1-4;

FIG. 9 is a block diagram of an exemplary gaming network that includes a plurality of gaming machines, such as the gaming machine shown in FIGS. 1-4; and

FIG. 10 is a flowchart that illustrates an exemplary method of assembling a gaming machine, such as the gaming machine shown in FIGS. 1-4.

### DETAILED DESCRIPTION OF THE INVENTION

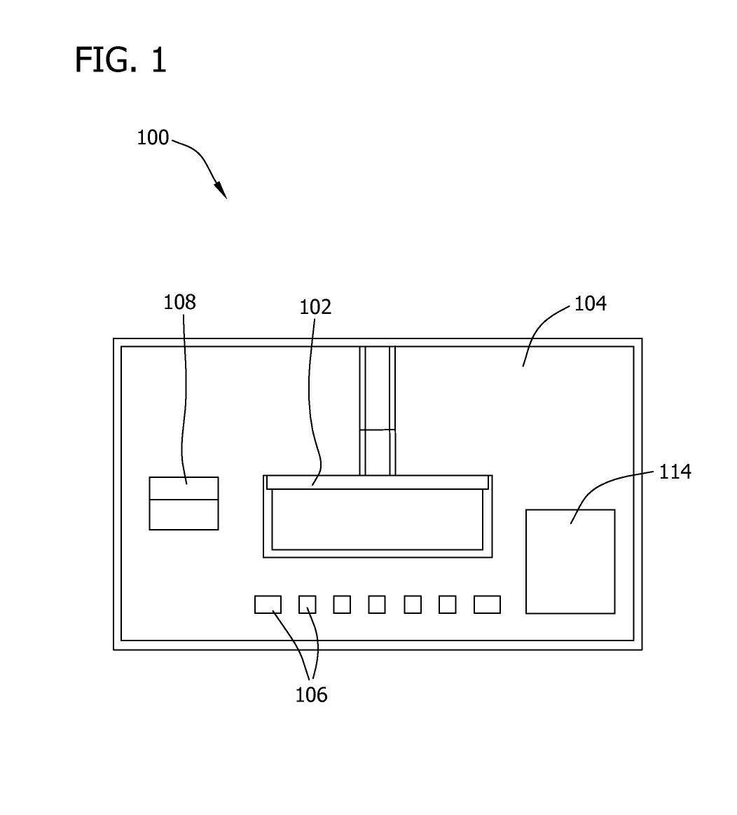

In some embodiments, as used herein, the term “mounting surface” refers generally to a surface that is capable of having a support assembly coupled thereto. For example, as shown in FIGS. 1-7, a “mounting surface” may be a bar top or a table top. Alternatively, such a surface may be provided on, for example, a side surface of a chair such as those found in casino sports books, a side surface of a cubicle such as those found in casino sports books, or a side surface of a bar or desk. Accordingly, a “mounting surface” may be any suitable surface to which a support assembly may be coupled in order to support a display device.

Exemplary applications of systems, methods, and apparatus according to the present invention are described herein. These examples are provided solely to add context and to aid in the understanding of the invention. It should thus be apparent to one skilled in the art that the present invention may be practiced without some, or without all, of these specific details. In other instances, well known process steps have not been described in detail in order to avoid unnecessarily obscuring the present invention. Other applications are possible, such that the following example should not be taken as definitive or limiting either in scope or setting. In the detailed description that follows, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting, such that other embodiments may be used and changes may be made without departing from the spirit and scope of the invention.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

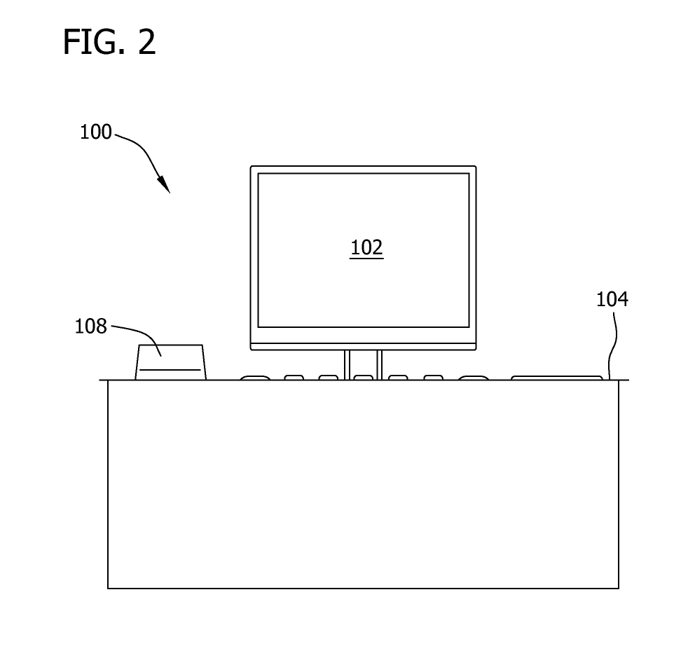

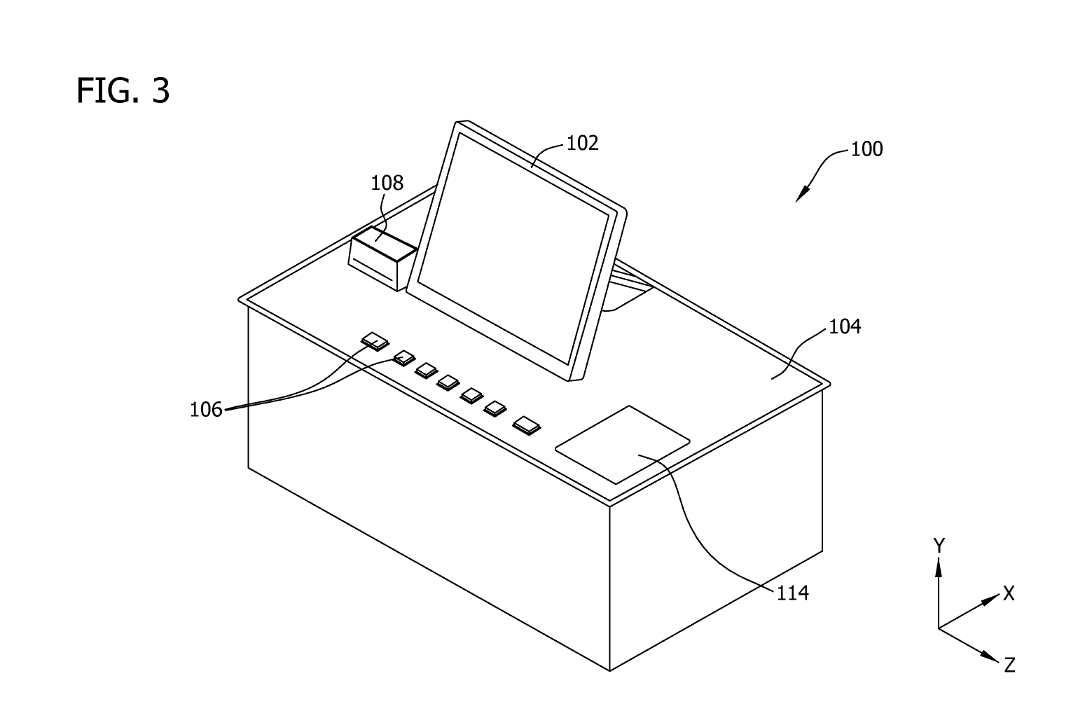

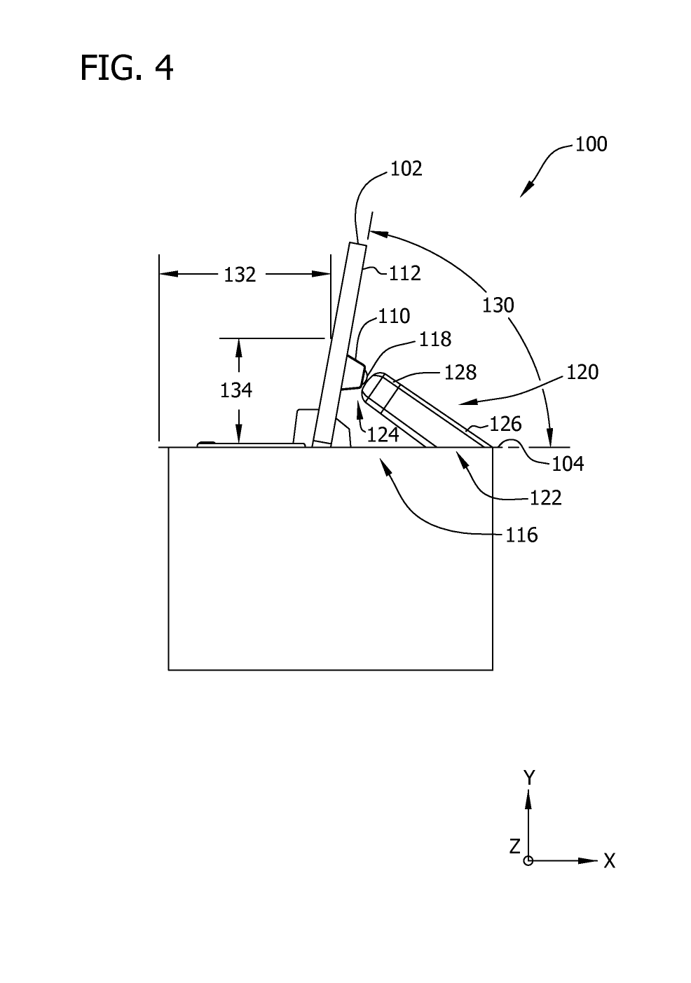

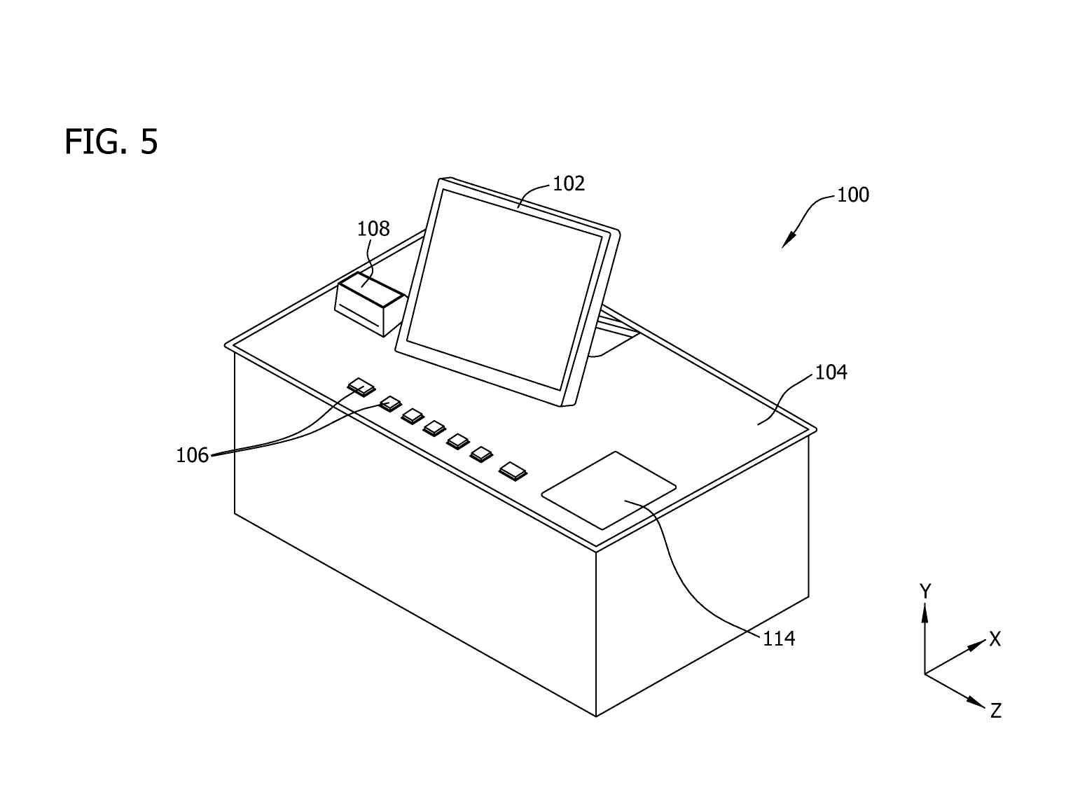

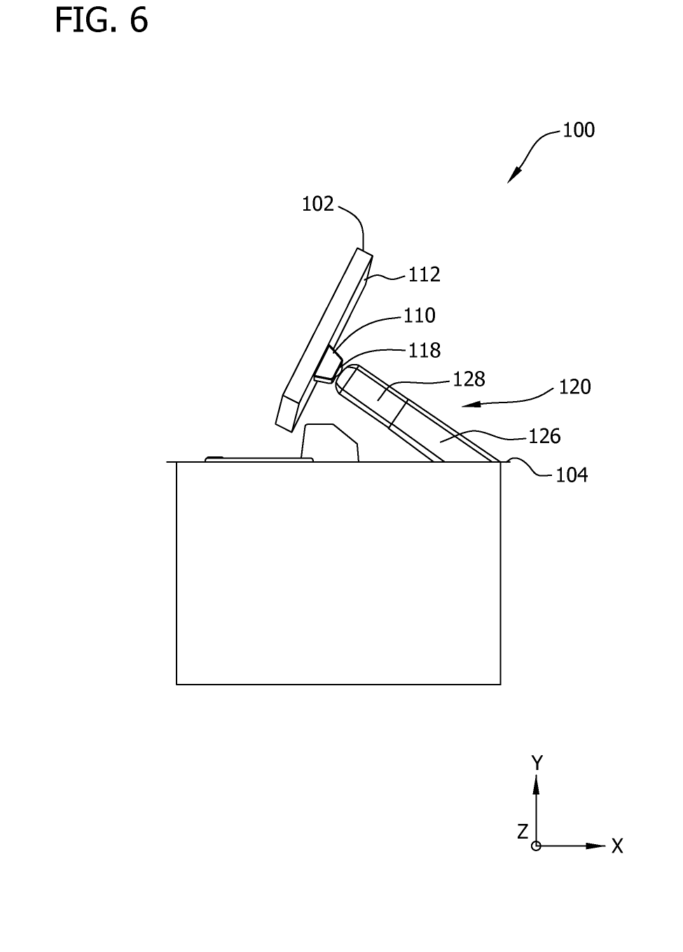

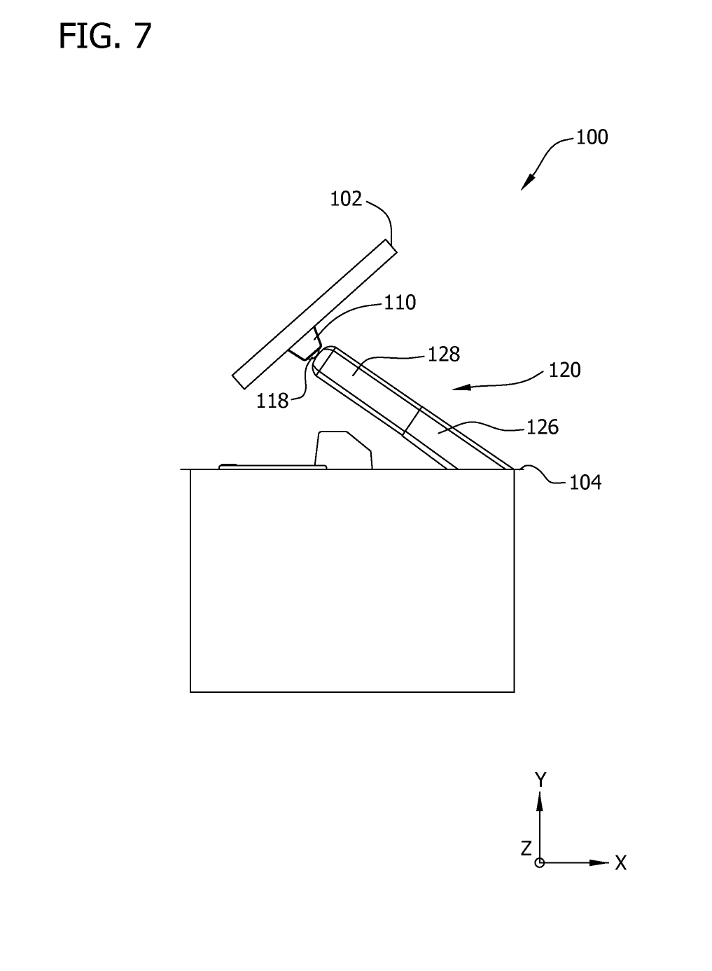

FIGS. 1-7 are schematic diagrams of an exemplary gaming machine 100. Specifically, FIG. 1 is a top schematic diagram of gaming machine 100, FIG. 2 is a front schematic diagram of gaming machine 100, and FIG. 3 is an isometric schematic diagram of gaming machine 100. Moreover, FIG. 4 is a side schematic diagram of gaming machine 100. FIG. 5 is an isometric schematic diagram of gaming machine 100 that illustrates relative movement of a display component, such as a video display monitor 102, of gaming machine 100 along the y-axis, and FIG. 6 is a side schematic diagram of gaming machine 100 that illustrates the relative movement of video display monitor 102 along the y-axis. Moreover, FIG. 7 is an isometric schematic diagram of gaming machine 100 that illustrates relative movement of video display monitor 102 along the z-axis.

In the exemplary embodiment, gaming machine 100 is coupled to a mounting surface 104, and includes a plurality of player-input buttons 106 and a credit device 108 that are coupled to mounting surface 104. Credit device 108 may include any suitable credit accepting and/or credit delivery device such as, but not limited to, a coin acceptor, a bill validator, a coin tray, a player tracking card acceptor, and/or a ticketing device. In the exemplary embodiment, video display monitor 102 includes a mounting receptacle 110 that is positioned along a portion of a rear surface 112 of video display monitor 102. In the exemplary embodiment, receptacle 110 is positioned in an approximately central location along rear surface 112. However, in alternative embodiments, receptacle 110 may be positioned in any suitable position along rear surface 112. In some embodiments, receptacle 110 is formed integrally with rear surface 112. In one embodiment, video display monitor 102 is a liquid crystal display (LCD) monitor. Alternatively, video display monitor 102 may be implemented using an organic light emitting diode (OLED) display monitor, a plasma display monitor, a multi-layer display (MLD), or any other suitable display device. Various embodiments of gaming machine 100 may utilize video display monitor 102 to provide features, such as bonus games and/or attract sequences, in addition to a base game being played on gaming machine 100.

In some embodiments, video display monitor 102 includes a secondary display (not shown in FIGS. 1-7) that is positioned along a portion of rear surface 112. For example, the secondary display may display information such as a cash out request input by the player, an operating state of gaming machine 100, or other pending player requests. The secondary display may be a liquid crystal display (LCD) monitor. Alternatively, the secondary display may be implemented using an organic light emitting diode (OLED) display monitor, a plasma display monitor, a multi-layer display (MLD), or any other suitable display device. Moreover, during normal play the secondary display may be obscured via a partially reflective shield. In order to view the displayed information, casino personnel may be required to actively illuminate a meter or similar event display device. Alternatively, the secondary display may only be active when attention is necessary, such that the secondary display is automatically illuminated to be visible through the shield.

Moreover, in the exemplary embodiment, gaming machine 100 also includes an information panel 114 that is positioned adjacent to player-input buttons 106. In the exemplary embodiment, information panel 114 is a back-lit, silk-screened glass panel, and includes lettering or other indicia that indicate general game information such as a number of coins played. Each of these devices is controlled by circuitry, such as a gaming machine controller (not shown in FIGS. 1-7).

In the exemplary embodiment, gaming machine 100 also includes a display mount assembly 116. Assembly 116 includes a pivot joint 118 that is coupled to receptacle 110, and a support arm 120 that extends between pivot joint 118 and mounting surface 102. Specifically, support arm 120 is coupled to mounting

In the exemplary embodiment, support arm 120 includes a first portion 126 and a second portion 128. First portion 126 is coupled to mounting surface 102 via first end 122. In some embodiments, first portion 126 is pivotably coupled to mounting surface 104 to facilitate movement about an axis, such as the z-axis. Moreover, in some embodiments, first portion 126 is pivotably coupled to second portion 128 to provide movement along an axis, such as the x-axis or the y-axis. Furthermore, in some embodiments, first portion 126 is sized and shaped to receive an insertion of second portion 128 therein. As such, in the exemplary embodiment, second portion 128 is linearly extendable from first portion 126. In one embodiment, a motor or actuator (not shown in FIGS. 1-7) is coupled to second portion 128 to facilitate linear movement of second portion 128 with respect to first portion 126 and, more particularly, to facilitate linear movement of video display monitor 102. In the exemplary embodiment, support arm 120 is hollow to enable video connector cables and/or audio connector cables (neither shown) to extend therethrough between video display monitor 102 and a gaming machine controller (not shown in FIGS. 1-7). Moreover, in one embodiment, mounting surface 104 may include a recessed pocket (not shown) that is sized and shaped to receive display mount assembly 116 when in a resting position. In such an embodiment, display mount assembly 116 may also include a latching mechanism (not shown) that secures a pivoting plate (not shown) in place over support arm 120. In the exemplary embodiment, display mount assembly 116 enables a player to adjust a viewing angle 130, a horizontal distance 132 from the player to video display monitor 102, and a vertical distance 134 between mounting surface 104 and video display monitor 102.

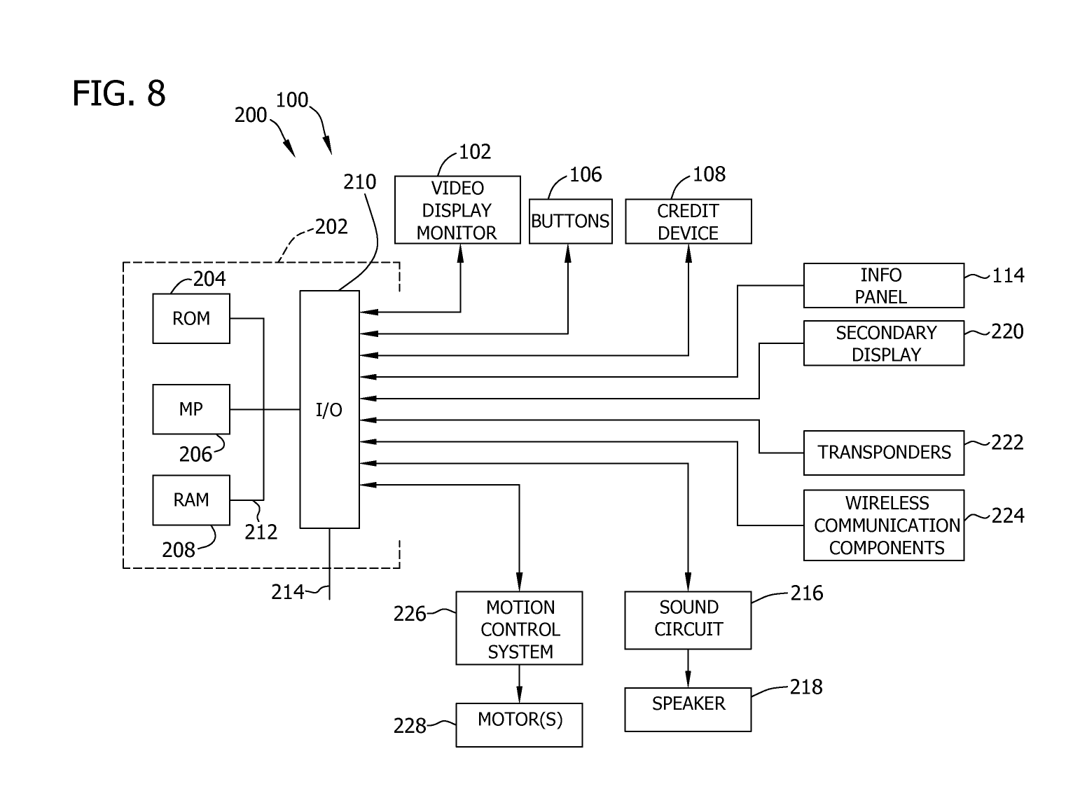

FIG. 8 is a block diagram of an exemplary electrical architecture 200 of gaming machine 100. In the exemplary embodiment, gaming machine 100 includes a gaming machine controller 202 that includes a read-only memory (ROM) 204, a microcontroller or microprocessor (MP) 206, a random-access memory (RAM) 208, and an input/output (I/O) circuit 210, that are each coupled via an address/data bus 212. As used herein, the terms “controller” and “processor” may include any programmable system including, but not limited to, systems using microcontrollers, reduced instruction set circuits (RISC), application specific integrated circuits (ASICs), logic circuits, and/or any other circuit or processor capable of executing the functions described herein. Such examples are exemplary only, and are thus not intended to limit in any way the definition and/or meaning of the terms “controller” or “processor”. Alternative embodiments of controller 202 may include more than one microprocessor 206, multiple RAM modules 208, and/or multiple ROM modules 204. Moreover, although I/O circuit 210 is shown in FIG. 8 as a single component, one of ordinary skill in the art should appreciate that I/O circuit 210 may include any number or a plurality of different types of I/O circuits.

Furthermore, RAM 208 and/or ROM 204 may be implemented as, for example, semiconductor memories, magnetically readable memories, and/or optically readable memories. ROM 204 may include disk memory, FLASH memory, EPROMs, or any suitable memory device. Moreover, RAM 208 and/or ROM 204 may be configured to store information such as configuration software that controls parameters and/or settings for game play using gaming machine 100, associations between configuration indicia read with one or more parameters and/or settings, communication protocols that enable controller 202 to communicate via I/O circuit 210, and/or communication transport protocols that enable controller 202 to communicate with local and non-local gaming machines via a gaming network (not shown). Communication transport protocols may include TCP/IP, USB, Firewire® (Firewire® is a registered trademark of Apple Computer, Inc., Cupertino, Calif., USA), IEEE 1394, Bluetooth® (Bluetooth® is a registered trademark of Bluetooth Sig, Inc., Bellevue, Wash., USA), IEEE 802.11x, hiperlan/2, HomeRF, ETHER Net, RS-485, or any other suitable protocol. RAM 208 and/or ROM 204 may also store one or more device drivers that use a communication protocol to enable communication between controller 202 and a particular device. For example, when a specific video display monitor 102 is exchanged for a different (e.g., larger) video display monitor 102, a new device driver may be loaded from RAM 208 and/or ROM 204 to enable communication between controller 202 and the new video display monitor 102.

In one embodiment, each operational component of gaming machine 100 is coupled to I/O circuit 210 via a respective conductor. Alternative embodiments may include only a single coupling between the operational components of gaming machine 100 and I/O circuit 210. In the exemplary embodiment, I/O circuit 210 is coupled to a gaming network (not shown) via a network interface 214. Moreover, in the exemplary embodiment, architecture 200 includes a sound circuit 216 that generates audio signals and that communicates audio signals between I/O circuit 210 and one or more speakers 218. I/O circuit 210 also facilitates communication between controller 202 and other peripheral devices such as a secondary display device 220, transponders 222, wireless communication components 224, and/or a motion control system 226 that includes one or more motors 228. In some embodiments, motors 228 facilitate movement of video display monitor 102 alone one or more axes, as described above.

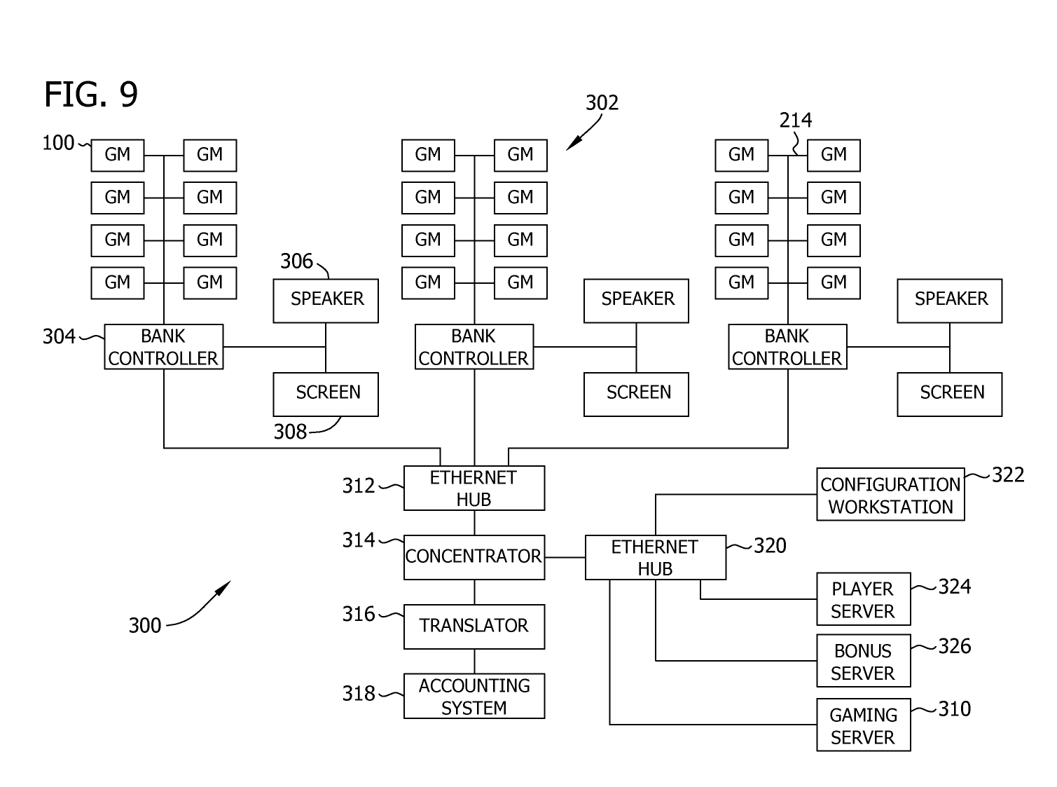

FIG. 9 is a block diagram of an exemplary gaming network 300 that includes a plurality of gaming machines 100. Specifically, FIG. 9 illustrates three banks 302 of gaming machines 100. Each gaming machine 100 is coupled via a network connection 214 to a bank controller 304. In one embodiment, each bank controller 304 includes a processor (not shown) that facilitates data communication between each gaming machine 100 within each bank 302, and between each gaming machine 100 and other components of gaming network 300. In one embodiment, each bank controller 304 also includes audio capabilities, such as a CD-ROM drive (not shown) or DVD-ROM drive (not shown), that are coupled to a sound card (not shown) for processing and transmitting digitized sound effects to one or more speakers 306 in response to commands issued over gaming network 300 by bank controller 304. Each bank controller 304 is also coupled via gaming network 300 to an electronic sign or screen 308 that displays information, such as via scrolling and/or flashing messages that indicate, for example, progressive and/or jackpot amounts, and that are visible to players playing gaming machines 100. Messages for display on each electronic screen 308 are generated and/or modified in response to commands issued over gaming network 300 by bank controller 304.

As described above, gaming machines 100 may include video poker machines, video slot machines, and/or other similar gaming machines that implement alternative games. Moreover, gaming machines 100 may be terminal-based machines, wherein the actual games, including random number generation and/or outcome determination, are performed at a remote gaming server 310. In such an embodiment, gaming machine 100 displays results of the game played on gaming server 310 via video display monitor 102 (shown in FIG. 1).

A network connector, such as an Ethernet hub 312, couples each bank controller 304 to a concentrator 314. Concentrator 314 functions as a data control switch that routes data from each bank 302 to a translator 316. Translator 316 provides a compatibility buffer (not shown) between concentrator 314 and an accounting system 318. Moreover, translator 316 converts data gathered from each bank 302 into a format that is compatible with accounting system 318.

Another Ethernet hub 320 couples concentrator 314 to a configuration workstation 322, a player server 324, and to one or more bonus servers 326. Configuration workstation 322 includes a user interface that enables an administrator to set up and/or to modify portions of gaming network 300 and/or servers 310, 324, and 326. Player server 324 tracks data of players using gaming machines 100. Player server 324 also controls messages that appear on each video display monitor 102 and/or information panel 114 of gaming machines 100. In the exemplary embodiment, player server 324 also stores physical characteristics of players, such as the player age and/or vision data. Accordingly, motion control system 226 (shown in FIG. 8) may automatically move video display monitor 102 (shown in FIGS. 1-8) into a predetermined position based on stored characteristics about a particular player. Bonus server 326 controls bonus applications or bonus systems on gaming network 300. Bonus server 326 includes a set of rules for awarding jackpots in excess of those established by winning pay tables (not shown) of each gaming machine 100. Some bonus awards may be awarded randomly, while other bonus awards may be made to groups of gaming machines 100 operating in a progressive jackpot mode.

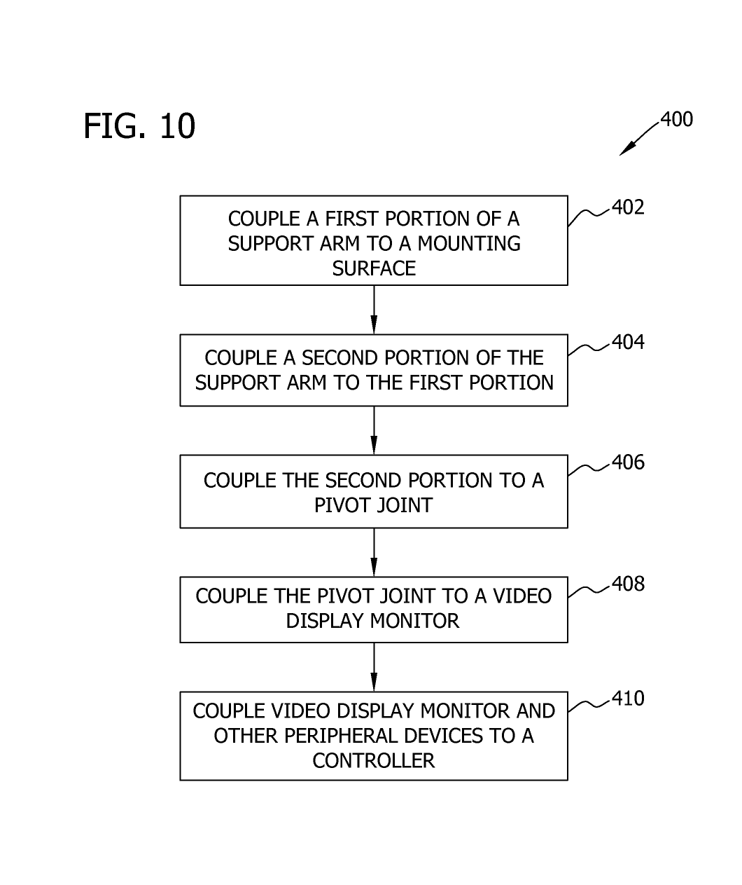

FIG. 10 is a flowchart 400 that illustrates an exemplary method of assembling a gaming machine, such as gaming machine 100 (shown in FIGS. 1-8). In the exemplary embodiment, and referring to FIGS. 1-8, support arm 120 is coupled 402 to mounting surface 104. Specifically, first end 122 of support arm 120 is coupled to mounting surface 104. In one embodiment, first end 122 is pivotably coupled to mounting surface 104 to facilitate movement about an axis. In the exemplary embodiment, support arm first portion 126 includes first end 122, and support arm second portion 128 includes second end 128. As such, in the exemplary embodiment, second portion 128 is coupled 404 to first portion 126. In one embodiment, second portion 128 is pivotably coupled to first portion 126. In some embodiments, support arm second portion 128 is coupled to support arm first portion 126 such that second portion 128 is linearly extendable from first portion 126 to provide linear movement of video display device 102. Moreover, in one embodiment, the linear movement is provided by a motor, such as motor 228, that is coupled to second portion 128.

In the exemplary embodiment, second end 124 is then coupled 406 to pivot joint 118. Specifically, support arm second end 124 is coupled to pivot joint 118. Pivot joint 118 is then coupled 408 to video display monitor 102. Specifically, pivot joint 118 is coupled to receptacle 110 to facilitate movement along at least two axes. In the exemplary embodiment, pivot joint 118 is a universal joint that provides movement along three axes. In one embodiment, pivot joint 118 is coupled to a motor, such as motor 228, to facilitate movement along one or more of the three axes.

In the exemplary embodiment, video display monitor 102, information panel 114, player input buttons 106, credit device 108, and/or secondary display 220 are coupled 410 to controller 202 via one or more connectors. Specifically, the connectors extend from controller 202 to video display monitor 102, information panel 114, player input buttons 106, credit device 108, and/or secondary display 220 through support arm 120. Moreover, in the exemplary embodiment, controller 202 is coupled to gaming system 300 via network 214 to facilitate communicating with, for example, servers 310, 324, and/or 326.

The systems, methods, and apparatus described herein facilitate optimizing a viewing angle of a gaming machine display for a player to counteract, for example, light glare and the like. Moreover, the systems, methods, and apparatus facilitate engagement of multiple players using a single gaming machine, as well as screening unwanted players from attempting to become engaged at a single gaming machine. Enabling movement of a video display monitor enables a player to define a desired gaming machine viewing angle, thereby ensuring correct ergonomics. Further, enabling movement of a video display monitor facilitates reclaiming counter space for use in placing food, drinks, and the like while maintaining an unobstructed view of the video display monitor. The modular construction of the embodiments described herein facilitate easily replacing a video display monitor by simply detaching the display and plugging a replacement in the same position.

When introducing elements of aspects of the invention or embodiments thereof, the articles “a,” “an,” “the,” and “said” are intended to mean that there are one or more of the elements. The terms “comprising,” including,” and “having” are intended to be inclusive and mean that there may be additional elements other than the listed elements.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A gaming machine coupled to a mounting surface, said gaming machine comprising:
a display comprising a receptacle positioned on a rear surface of said display; and
a display mount assembly comprising:
a support arm comprising a first end and an opposite second end, said first end coupled to the mounting surface; and
a pivot joint coupled to said receptacle and to said support arm second end such that said pivot joint provides movement of said display along at least two axes.

2. A gaming machine in accordance with claim 1, wherein said receptacle is formed integrally with said display rear surface.

3. A gaming machine in accordance with claim 1, wherein said display comprises an accelerometer configured to detect rotational movement of said display along at least one of the at least two axes.

4. A gaming machine in accordance with claim 1, wherein said support arm is pivotably coupled to the mounting surface to provide movement of said display along a third axis.

5. A gaming machine in accordance with claim 1, wherein said support arm comprises a first portion and a second portion, said first portion is pivotably coupled to said second portion.

6. A gaming machine in accordance with claim 5, wherein said second portion is linearly extendable from said first portion to provide movement of said display.

7. A gaming machine in accordance with claim 6, further comprising a motor coupled to said second portion, wherein said motor is configured to cause the linear movement of said display.

8. A gaming machine in accordance with claim 1, further comprising a motor coupled to one of said receptacle and to said support arm second end, wherein said motor is configured to cause the movement of said display along at least one of the at least two axes.

9. A gaming machine in accordance with claim 1, further comprising a controller coupled to said display via at least one connector that extends from said processor to said display through said support arm.

10. A gaming machine in accordance with claim 1, further comprising a secondary display positioned along a portion of said display rear surface.

11. A display mount assembly for use with a gaming machine that includes a display, said display mount assembly comprising:
a support arm comprising a first end and an opposite second end, said first end is coupled to a mounting surface; and
a pivot joint coupled to the display and to said second end such that said pivot joint provides movement of the display along at least two axes.

12. A display mount assembly in accordance with claim 11, wherein said support arm is pivotably coupled to the mounting surface to provide movement of said display along a third axis.

13. A display mount assembly in accordance with claim 11, wherein said support arm comprises a first portion and a second portion, said first portion is pivotably coupled to said second portion.

14. A display mount assembly in accordance with claim 13, wherein said second portion is linearly extendable from said first portion to provide movement of said display.

15. A display mount assembly in accordance with claim 14, further comprising a motor coupled to said second portion, wherein said motor is configured to cause the linear movement of said display.

16. A display mount assembly in accordance with claim 11, further comprising a motor coupled to one of said receptacle and to said support arm second end, wherein said motor is configured to cause the movement of said display along at least one of the at least two axes.

17. A method of assembling a gaming machine that includes a display and a display mount assembly having a support arm and a pivot joint, said method comprising:
coupling a first end of the support arm to a mounting surface;
coupling a second end of the support arm to the pivot joint; and
coupling the pivot joint to the display such that the pivot joint provides movement of the display along at least two axes.

18. A method in accordance with claim 17, wherein coupling a first end of the support arm to a mounting surface comprises pivotably coupling the first end to the mounting surface.

19. A method in accordance with claim 17, wherein the support arm includes a first portion and a second portion, said method further comprises coupling the first portion to the second portion such that the second portion is linearly extendable from the first portion to provide linear movement of the display.

20. A method in accordance with claim 19, wherein the display mount assembly includes a motor, said method further comprises coupling the motor to the second portion such that the motor causes the linear movement of the display along the third axis.

21. A method in accordance with claim 17, wherein the support arm includes a first portion and a second portion, said method further comprises pivotably coupling the first portion to the second portion.

22. A method in accordance with claim 17, further comprising coupling a motor to the pivot joint such that the motor causes the movement of the display along at least one of the at least two axes.

23. A method in accordance with claim 17, wherein the gaming machine includes a controller, said method further comprises coupling the controller to the display via a connector that extends through the support arm.
